(19) United States
(12) Patent Application Publication
(10) Pub. No.: US 2008/0034222 A1
(43) Pub. Date: Feb. 7, 2008

(54) Mobile terminal, encrypted contents reproduction method and plaintext data generation method employed for the same

(76) Inventors: Yuishi Torisaki, Hyogo (JP); Makoto Fujiwara, Kyoto (JP)

Correspondence Address: MCDERMOTT WILL & EMERY LLP, 600 13TH STREET, N.W., WASHINGTON, DC, 20005-3096, US

(21) Appl. No.: 11/633,453

(22) Filed: Dec. 5, 2006

(30) Foreign Application Priority Data
Jan. 12, 2006 (JP) 2006-005159

(51) Int. Cl. G06F 12/14

(52) U.S. Cl. 713/193

(57) ABSTRACT

A mobile terminal adapted to reproduce an encrypted contents file stored in a predetermined storage area as an alert of an incoming call includes: a storage section for holding first plaintext data corresponding to a head portion of the encrypted contents file; decryption means for decrypting the encrypted contents file to generate second plaintext data; reproduction means for reproducing the first and second plaintext data; and authentication means for performing authentication processing related to use of the encrypted contents file. The reproduction means reproduces the first plaintext data and in succession to reproduction of the first plaintext data reproduces the second plaintext data when the mobile terminal receives a call. The authentication means performs the authentication processing simultaneously and in parallel with the reproduction of the first plaintext data by the reproduction means.

### CROSS-REFERENCE TO RELATED APPLICATIONS

This application claims priority under 35 U.S.C. §119 on Patent Application No. 2006-5159 filed in Japan on Jan. 12, 2006, the entire contents of which are hereby incorporated by reference.

### BACKGROUND OF THE INVENTION

1. Field of the Invention

The present invention relates to an encrypted contents reproduction technology for mobile terminals that reproduce an encrypted contents file as an alert of an incoming call.

2. Description of the Related Art

With speedups in networks and enhancement in the functions of mobile terminals, it has become common for the mobile terminals to download music contents of the same quality as those presented via compact discs and the like and reproduce the downloaded music. Such music contents have been encrypted for copyright protection. To reproduce the music, therefore, authentication processing such as key generation and right confirmation is necessary.

Such music contents can also be used as an alert of an incoming call. FIG. 9 shows a processing time series of reproduction of encrypted contents at the arrival of a call. When a mobile terminal receives a call (t0), authentication processing for an encrypted contents file set as call notification is started. Once the authentication processing succeeds, decryption of the encrypted contents file is started (t1), and then reproduction of plaintext data generated as a result of the decryption is started (t2). Thus, in use of encrypted music contents as notification of an incoming call, the time Ts from the arrival of a call at the mobile terminal (t0) until the start of reproduction of plaintext data (t2) constitutes a silence period. In other words, reproduction of the music contents is missed during the time required for the authentication processing and the decryption of a head portion of the encrypted contents file. Therefore, there arises a problem of failing to achieve prompt reproduction of music contents, which is a requisite for notification of an incoming call.

For achievement of prompt reproduction of music contents at the arrival of a call, proposed has been a technology in which one stage of music contents out of two-stage compressed music contents is decrypted in advance and stored in a storage area to lessen the processing required at the reproduction. With this technology, the time required for reproduction of music contents is shortened (see Japanese laid-Open Patent Publication No. 2002-091436, for example).

In the technology described above, while the time required for the decryption of an encrypted contents file is shortened, the time required for the authentication processing cannot be shortened. Therefore, there still exists the silent period from the arrival of a call until reproduction of encrypted contents.

To eliminate the silent period, some methods are contemplated, including the method in which an encrypted contents file is decrypted in advance and held in a storage area in a reproduction-ready state and the method in which the processing capability of CPU is enhanced. These methods however have the following problems. Holding an encrypted contents file in the decrypted state is against the copyright protection. A CPU high in processing capability will increase the cost and the power consumption. These simple solutions are therefore not likely to be adopted.

### SUMMARY OF THE INVENTION

An object of the present invention is providing a technology for mobile terminals that reproduce an encrypted contents file as an alert of an incoming call, in which prompt reproduction of the contents at the arrival of a call can be achieved without especially increasing the CPU operation speed while securing the copyright protection of the encrypted contents file.

To attain the object described above, the present invention is directed to a mobile terminal adapted to reproduce an encrypted contents file stored in a predetermined storage area as an alert of an incoming call. The mobile terminal includes: a storage section for holding first plaintext data corresponding to a head portion of the encrypted contents file; decryption means for decrypting the encrypted contents file to generate second plaintext data; reproduction means for reproducing the first and second plaintext data; and authentication means for performing authentication processing related to use of the encrypted contents file, wherein the reproduction means reproduces the first plaintext data and in succession to reproduction of the first plaintext data reproduces the second plaintext data when the mobile terminal receives a call, and the authentication means performs the authentication processing simultaneously and in parallel with the reproduction of the first plaintext data by the reproduction means.

According to the configuration described above, when the mobile terminal receives a call, the authentication processing related to use of the encrypted contents file by the authentication means and the reproduction of the first plaintext data stored in the storage section by the reproduction means are performed simultaneously and in parallel with each other, to allow the second plaintext data decrypted by the decryption means to be reproduced in succession to the reproduction of the first plaintext data. Thus, prompt contents reproduction at the arrival of a call can be achieved without especially increasing a CPU operation speed in the mobile terminal. Also, the copyright protection is secured since only a head portion of the encrypted contents file has been decrypted into plaintext data and held.

Preferably, the mobile terminal described above further includes a control section for instructing the decryption means to decrypt the encrypted contents file if the authentication processing by the authentication means succeeds, and instructing the reproduction means to stop the reproduction of the first plaintext data if the authentication processing fails.

Preferably, the storage section is a secure memory.

Preferably, the remaining portion of the encrypted contents file excluding the head portion is stored in the predetermined storage area as the encrypted contents file.

Alternatively, the present invention is directed to a method for reproducing an encrypted contents file as an alert of an incoming call in a mobile terminal, first plaintext data corresponding to part of the encrypted contents file including a head portion thereof being held in a predetermined storage area. The encrypted contents reproduction method includes the steps of: (1) reproducing the first plaintext data when the mobile terminal receives a call; (2) performing authentication processing related to use of the encrypted contents file simultaneously and in parallel with the step (1); (3) decrypting the encrypted contents file to generate second plaintext data if the authentication processing in the step (2) succeeds; and (4) reproducing the second plaintext data in succession to the step (1).

According to the method described above, when the mobile terminal receives a call, the reproduction of the first plaintext data stored in a predetermined storage area and the authentication processing related to use of the encrypted contents file are performed simultaneously and in parallel with each other. Once the authentication processing succeeds, the encrypted contents file is decrypted, to allow the decrypted second plaintext data to be reproduced in succession to the reproduction of the first plaintext data to continue from the first plaintext data. Thus, prompt contents reproduction at the arrival of a call can be achieved without especially increasing a CPU operation speed in the mobile terminal. Also, the copyright protection is secured since only a head portion of the encrypted contents file has been decrypted into plaintext data and held.

Specifically, the first plaintext data may be data corresponding to a predetermined reproduction time.

Otherwise, the first plaintext data may be data having a predetermined data size.

Otherwise, the first plaintext data may be data corresponding to a predetermined number of frames.

Alternatively, the present invention is directed to a method for reproducing an encrypted contents file as an alert of an incoming call in a mobile terminal, plaintext data corresponding to the encrypted contents file being stored in a secure memory. The encrypted contents reproduction method includes the steps of: (1) reproducing the plaintext data when the mobile terminal receives a call; and (2) performing authentication processing related to use of the encrypted contents file simultaneously and in parallel with the step (1).

According to the method described above, when the mobile terminal receives a call, the reproduction of the plaintext data stored in the secure memory and the authentication processing related to use of the encrypted contents file are performed simultaneously and in parallel with each other. Thus, prompt music reproduction at the arrival of a call can be achieved without especially increasing a CPU operation speed in the mobile terminal. Also, the copyright protection is secured since the plaintext data is stored in the secure memory. Moreover, processing required at the arrival of a call is lessened since no decryption processing is necessary.

Preferably, the encrypted contents reproduction method described above further includes the step (3) of stopping the reproduction of the plaintext data if the authentication processing in the step (2) fails.

Preferably, the encrypted contents reproduction method described above further includes the step (4) of deleting the plaintext data if the authentication processing in the step (2) fails.

Alternatively, the present invention is directed to a method for generating the first plaintext data, employed in the encryption contents reproduction method described above. The plaintext data generation method includes the steps of: (1) decrypting part of the encrypted contents file including a head portion thereof; and (2) storing data decrypted in the step (1) in the predetermined storage area as the first plaintext data.

Specifically, in the step (1), in a first case that a frame break of the encrypted contents file exists within a predetermined range of reproduction time, encrypted data from the head of the encrypted contents file until the frame break may be decrypted, and in a second case other than the first case, encrypted data from the head of the encrypted contents file until an upper limit of the range may be decrypted. In the step (2), in the second case, data corresponding to a reproduction time within the range may be stored in the predetermined storage area.

Otherwise, in the step (1), in a first case that a frame break of the encrypted contents file exists within a predetermined range of data size, encrypted data from the head of the encrypted contents file until the frame break may be decrypted, and in a second case other than the first case, encrypted data from the head of the encrypted contents file until an upper limit of the range may be decrypted. In the step (2), in the second case, data corresponding to a data size within the range may be stored in the predetermined storage area.

Preferably, the step (1) is executed when the encrypted contents file is determined as an alert of an incoming call.

Preferably, the step (1) is executed when the encrypted contents file is stored in a predetermined storage area.

As described above, according to the present invention, in a mobile terminal that reproduces an encrypted contents file as an alert of an incoming call, prompt contents reproduction can be achieved while the copyright protection of the encrypted contents file is secured.

### BRIEF DESCRIPTION OF THE DRAWINGS

FIG. 1 is a view illustrating a configuration of a mobile terminal of an embodiment of the present invention.

FIG. 2 is a view showing a processing time series of an encrypted contents reproduction method.

FIG. 3 is a view showing a processing time series at the occurrence of authentication failure.

FIG. 4 is a view showing an example of decryption and reproduction processing of encrypted contents.

FIG. 5 is a view showing a processing time series of a plaintext data generation method.

FIG. 6 is a view showing an outline of an example of plaintext data generation.

FIGS. 7A and 7B are views showing outlines of another example of plaintext data generation.

FIG. 8 is a view showing a processing time series of an alternative plaintext data generation method and encrypted contents reproduction method.

FIG. 9 is a view showing a processing time series of reproduction of encrypted contents at the arrival of a call.

### DESCRIPTION OF THE PREFERRED EMBODIMENTS

Hereinafter, preferred embodiments of the present invention will be described with reference to the accompanying drawings.

### Embodiment of Mobile Terminal

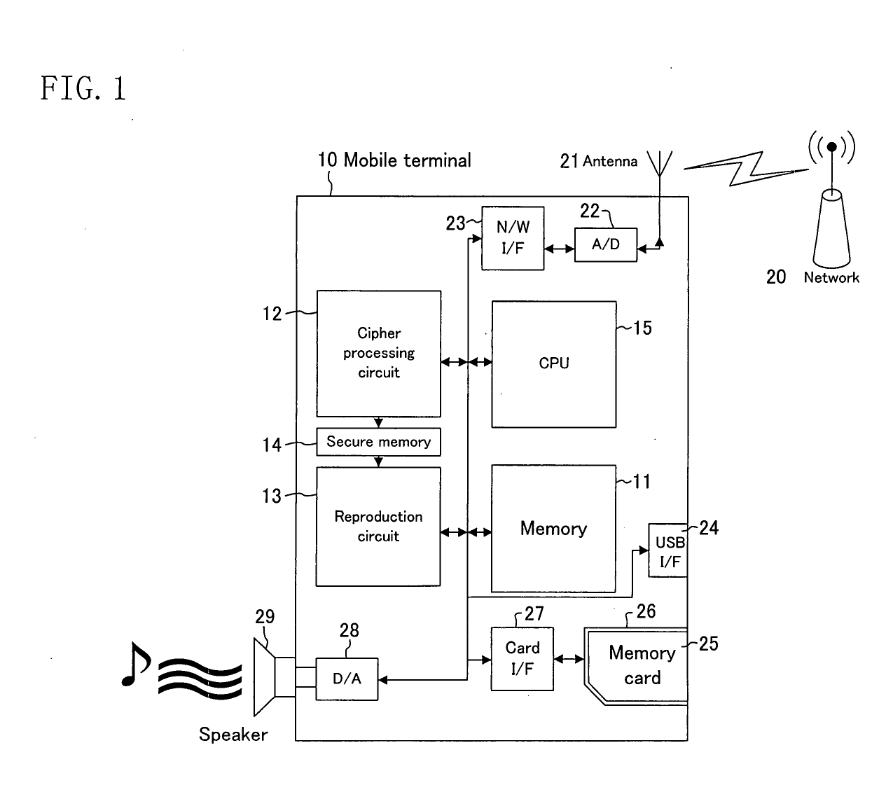

FIG. 1 shows a configuration of a mobile terminal of an embodiment of the present invention. The mobile terminal 10 includes a memory 11, a cipher processing circuit 12 as the authentication means and the decryption means, a reproduction circuit 13 as the reproduction means, a secure memory 14 and a CPU 15. Note that all or some of these components may be mounted on the same LSI.

An encrypted contents file received via an antenna 21 through a network 20 is stored in the memory 11 through an A/D converter 22 and a network interface 23. Alternatively, an encrypted contents file may be transferred from a computer (not shown) and the like via a USB interface 24. The memory 11 also stores therein right information and other information such as an encryption key for the encrypted contents file, as well as an information table associating these units of data with one another.

The cipher processing circuit 12 performs authentication processing using the encrypted contents file and its right information and encryption key stored in the memory 11, and if succeeding in the authentication, decrypts the encrypted contents file.

The reproduction circuit 13 reproduces plaintext data decrypted by the cipher processing circuit 12 and stored in the memory 11 or the security memory 14 to be described later. The plaintext data reproduced by the reproduction circuit 13 is output from a speaker 29 via a D/A converter 28 as an audio signal.

The secure memory 14 is a storage area read from which is not allowed externally. The secure memory 14 is accessible from the cipher processing circuit 12 and the reproduction circuit 13.

The CPU 15 controls the operations of the cipher processing circuit 12 and the reproduction circuit 13. More specifically, the CPU 15 controls the cipher processing circuit 12 to start decryption of the encrypted contents file once the authentication processing is successful. If the authentication processing fails, the CPU 15 controls the reproduction circuit 13 to stop reproduction of plaintext data.

The encrypted contents file may be stored in a memory card 25. In this case, the encrypted contents file is sent to the cipher processing circuit 12 via a memory card slot 26 and a card interface 27, to be subjected to the authentication processing and the decryption processing in the cipher processing circuit 12.

The authentication processing, the decryption processing and the reproduction processing may be software-controlled with the CPU 15.

A privilege mode may be provided in the CPU 15 to permit a program processed in the privilege mode to access the secure memory 14. The secure memory 14 may be omitted, and instead part of the memory 11 may be access-limited and used as a secure memory.

Next, an encrypted contents reproduction method at the arrival of a call, as well as a plaintext data generation method employed for the reproduction method, for the mobile terminal 10 will be described.

<Encrypted Contents Reproduction Method>

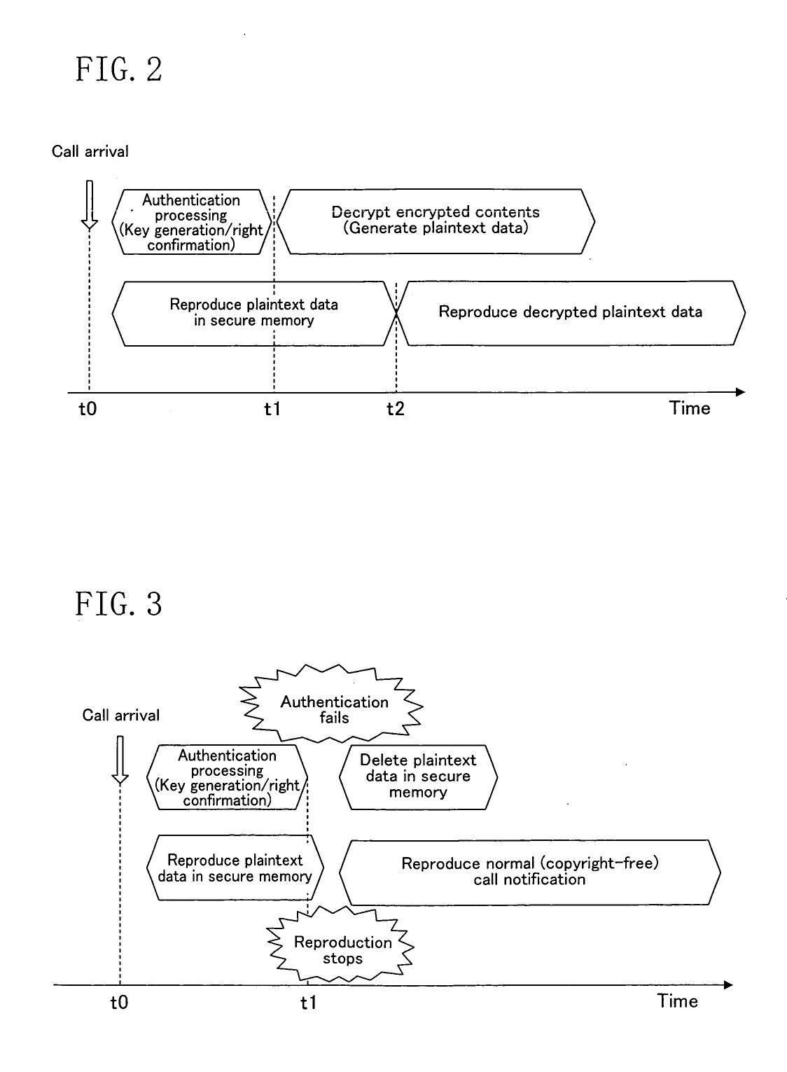

FIG. 2 shows a processing time series of the encrypted contents reproduction method for the mobile terminal 10. The secure memory 14 of the mobile terminal 10 stores therein plaintext data corresponding to a head portion of the encrypted contents file stored in the memory 11 or the memory card 25.

When the mobile terminal 10 receives a call (t0), reproduction of the plaintext data stored in the security memory 14 and authentication processing related to use of the encrypted contents file stored in the memory 11 or the memory card 25 are started simultaneously and performed in parallel with each other. Once the authentication processing succeeds (t1), decryption of the encrypted contents file stored in the memory 11 or the memory card 25 is started, to generate plaintext data. Reproduction of the decrypted plaintext data is then started (t2) in succession to the reproduction of the plaintext data stored in the secure memory 14 to continue from the plaintext data.

FIG. 3 shows a processing time series observed when the authentication processing fails. If the authentication processing fails (t1), the reproduction of the plaintext data stored in the secure memory 14 is stopped. Instead, reproduction of preset copyright-free contents is started, and the plaintext data stored in the secure memory 14 is deleted.

As described above, by performing the reproduction of pre-decrypted plaintext data corresponding to a head portion of the encrypted contents file simultaneously and in parallel with the authentication processing related to use of the encrypted contents file, reproduction of contents at the arrival of a call can be made promptly. Also, since only a head portion of the encrypted contents file is decrypted into plaintext data and held, the copyright protection is secured.

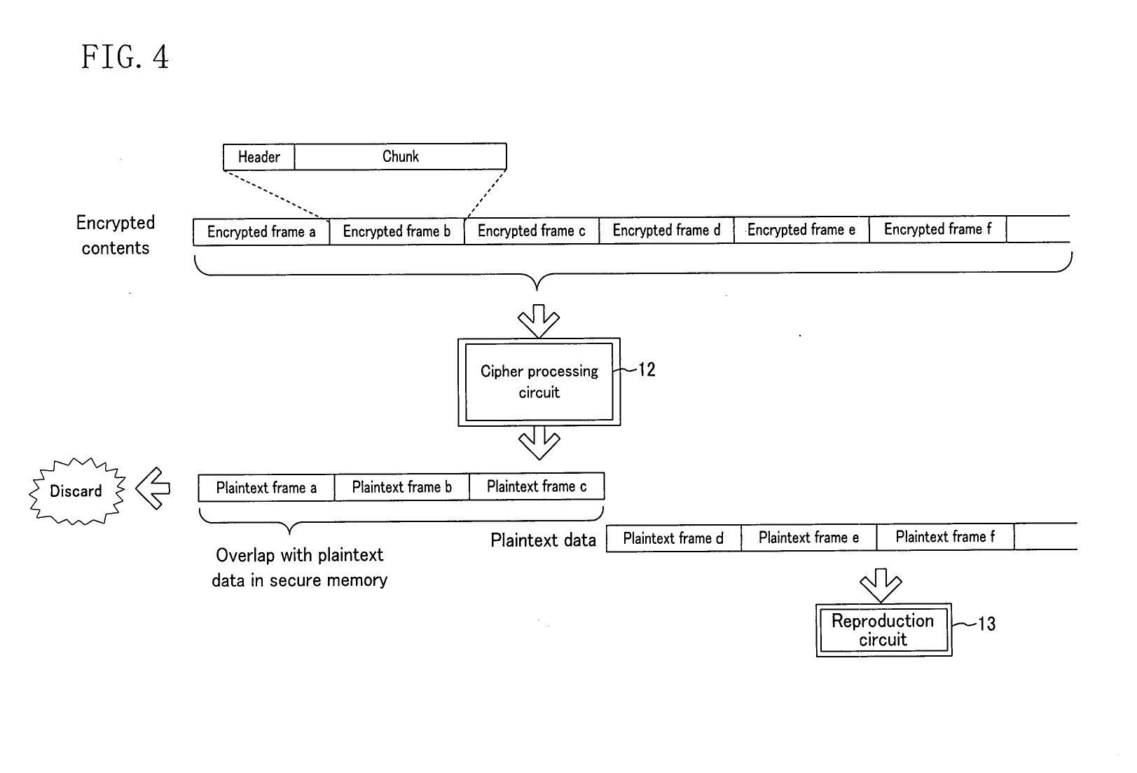

From the standpoint of reducing the memory consumption, only data excluding the head portion decrypted into plaintext data should preferably be stored in the memory 11 or the memory card 25 as the encrypted contents file. Alternatively, the downloaded data may be stored as it is. In this case, as shown in FIG. 4, the portion overlapping the plaintext data stored in the secure memory 14 (plaintext frames a to c in FIG. 4) may be discarded, and the remaining portion starting from plaintext data d may be reproduced.

<Plaintext Data Generation>

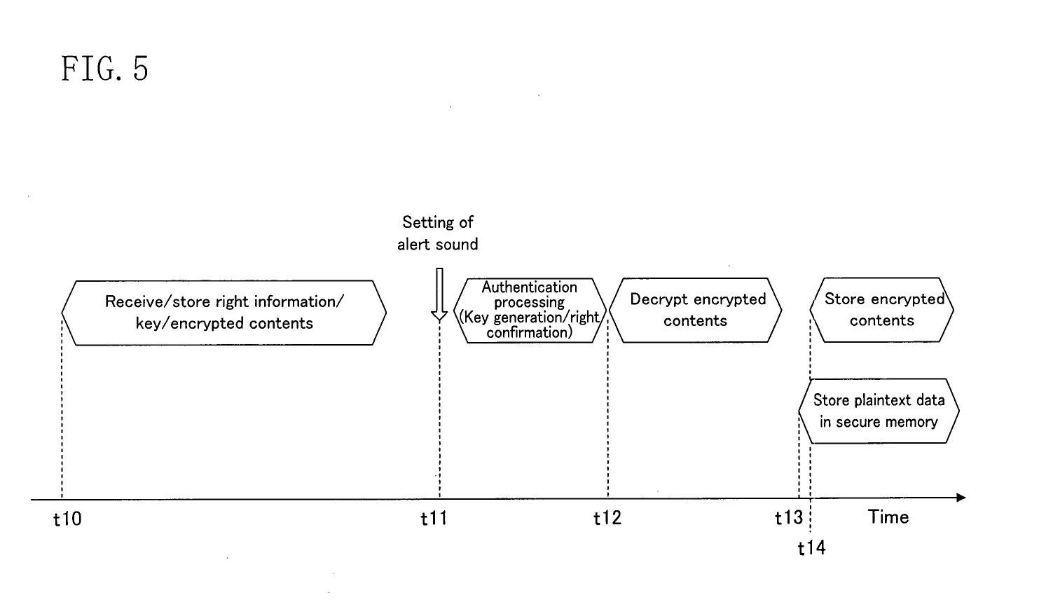

A method for generating plaintext data to be stored in the secure memory 14 will be described. FIG. 5 shows a processing time series of the plaintext data generation method. First, a downloaded encrypted contents file and its encrypted key and right information are stored in the memory 11 or the memory card 25 (t10). The encrypted contents file is copyrighted and thus requiring authentication processing at the time of reproduction. When the encrypted contents file is determined as notification of an incoming call (t11), authentication processing of the encrypted contents file stored in the memory 11 or the memory card 25 is started using the encryption key and the right information. Once the authentication processing succeeds, decryption of a head portion of the encrypted contents file is started (t12). The decrypted plaintext data is then stored in the secure memory 14 (t13). The remaining encrypted data excluding the head portion of the encrypted contents file is stored in the memory 11 or the memory card 25 (t14). If the authentication processing fails, no decryption of the encrypted contents file is performed, and thus no plaintext data is generated.

Alternatively, the generation of plaintext data may be performed when the encrypted contents file is stored in the memory 11 or the memory card 25.

### EXAMPLE 1 OF PLAINTEXT DATA GENERATION METHOD

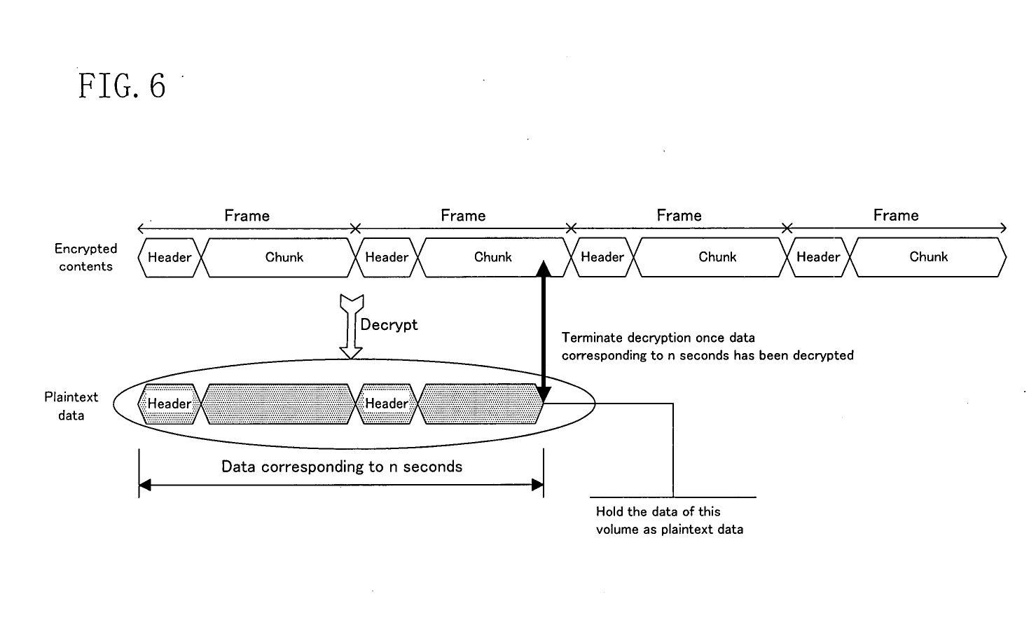

FIG. 6 shows an outline of an example of the plaintext data generation. In this example, plaintext data corresponding to a predetermined reproduction time is generated. The encrypted contents file stored in the memory 11 or the memory card 25 is composed of one or more frames. Each frame is composed of one header and at least one chunk (see FIG. 4). In this plaintext data generation method, decryption is started from the head of the encrypted contents file and terminated at the time point when plaintext data corresponding to n seconds has been generated. The time n may be set so as to be equal to or longer than the time required to complete the authentication processing of the encrypted contents file and the decryption processing of the head portion thereof from the arrival of a call at the mobile terminal 10. In general, the time required until reproduction is about one second.

Otherwise, plaintext data corresponding to a predetermined data size or a predetermined number of frames, in place of the generation time, may be generated.

### EXAMPLE 2 OF PLAINTEXT DATA GENERATION METHOD

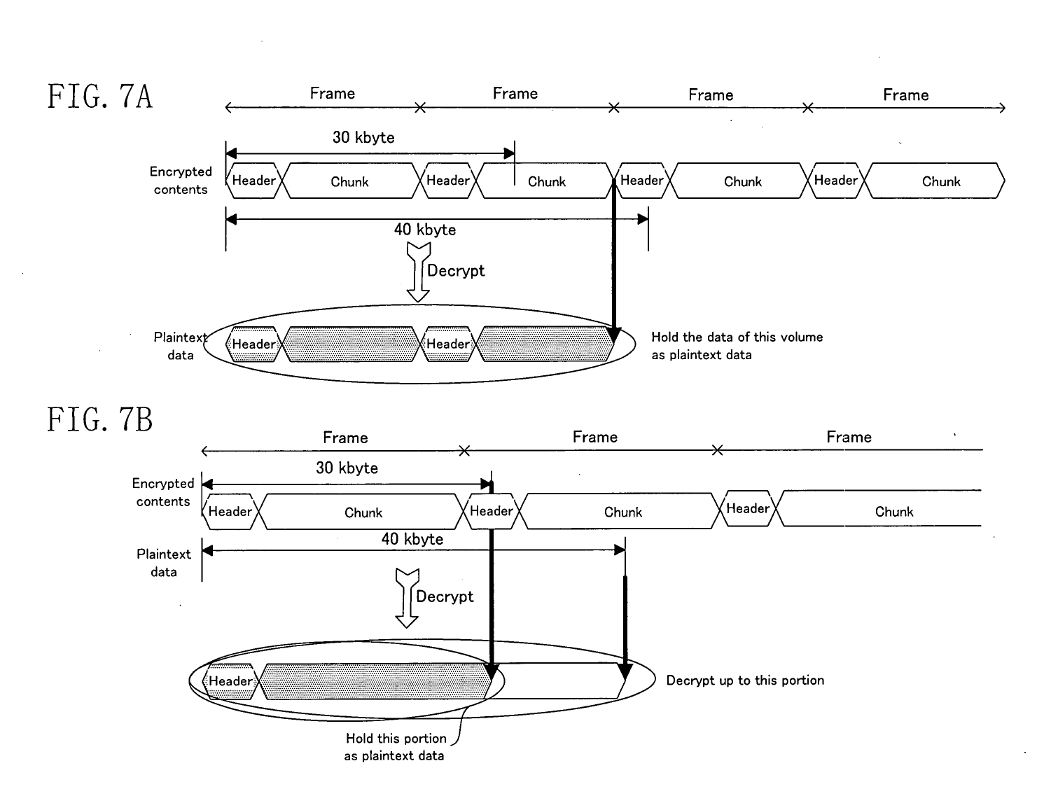

FIGS. 7A and 7B show outlines of another example of the plaintext data generation. In this example, plaintext data is generated based on the relationship between the range of 30 to 40 kbytes from the head of the encrypted contents file (hereinafter, referred to as the specified range) and the frame breaks.

FIG. 7A shows the case of plaintext data generation applied when there is a frame break of the encrypted contents file within the specified range. In this case, data from the head of the encrypted contents file until the break between the second and third frames is decrypted, and the decrypted data is stored in the secure memory 14. The remaining portion starting from the third frame is stored in the memory 11 or the memory card 25 as the encrypted contents file. In generation of plaintext data from the head until a frame break as in this case, generation/management of a chain key is unnecessary even if the contents file has been encrypted with a chain cipher.

FIG. 7B shows the case of plaintext data generation applied when there is no frame break of the encrypted contents file within the specified range. In this case, the decryption terminates at the point corresponding to 40 kbytes from the head of the encrypted contents file as the upper limit of the specified range, and the portion up to the point corresponding to 30 kbytes from the head of the decrypted data as the lower limit of the specified range is stored in the secure memory 14 as plaintext data. The remaining portion starting from the point corresponding to 30 kbytes is stored in the memory 11 or the memory card 25 as the encrypted contents file. In this case, a header required for decryption and reproduction is added to the encrypted contents file. Also, in the information table stored in the memory 11 or the memory card 25, a row for associating the encrypted contents file, its encryption key and right information and the plaintext data with one another is added. Moreover, a chain key for the portion up to the position corresponding to the tail of the plaintext data in the encrypted contents file is stored in the memory 11 or the memory card 25, and is used for decryption of the first frame at the decryption of the encrypted contents file.

The encrypted contents file stored in the memory 11 or the memory card 25 may otherwise be the remaining portion starting from the frame break located immediately before the position corresponding to the tail of the plaintext data. In this case, generation/management of a chain key is unnecessary even if the contents file has been encrypted with a chain cipher. Thus, the encrypted contents file stored in the memory 11 or the memory card 25 can be decrypted without consideration of a chain key.

The plaintext data stored in the secure memory 14 may have a data size within the specified range, and thus the copyright protection of the encrypted contents file is secured.

The setting of 30 kbytes as the lower limit of the specified range is a mere example. Any data size can be accepted as long as it corresponds to a reproduction time equal to or longer than the time required for the authentication processing related to use of the encrypted contents file and the decryption processing for a head portion thereof from the arrival of a call at the mobile terminal 10. Likewise, the setting of 40 kbytes as the upper limit of the specified range is a mere example. The setting may just be made to keep the data size of the plaintext data stored in the secure memory 14 from becoming large unintentionally, from the standpoint of copyright protection. The specified range may be changed appropriately depending on the format of the encrypted contents file stored in the memory 11 or the memory card 25.

The generation of the plaintext data may otherwise be made using a time range as the specified range.

The upper limit of the specified range may be omitted. That is, higher priority may be given to frame breaks than to the data size in generation of plaintext data.

(Alternative Plaintext Data Generation Method and Encrypted Contents Reproduction Method)

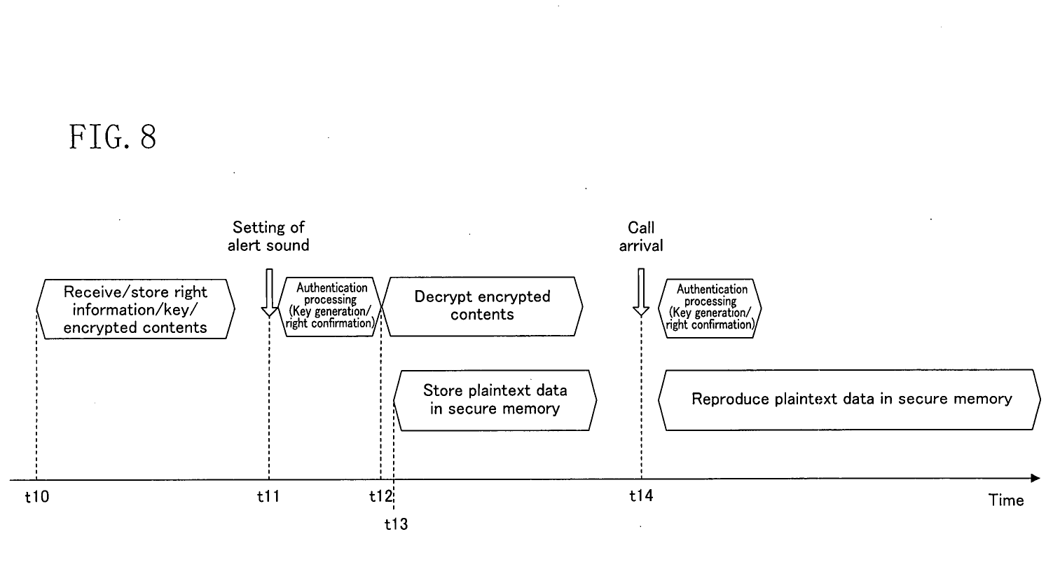

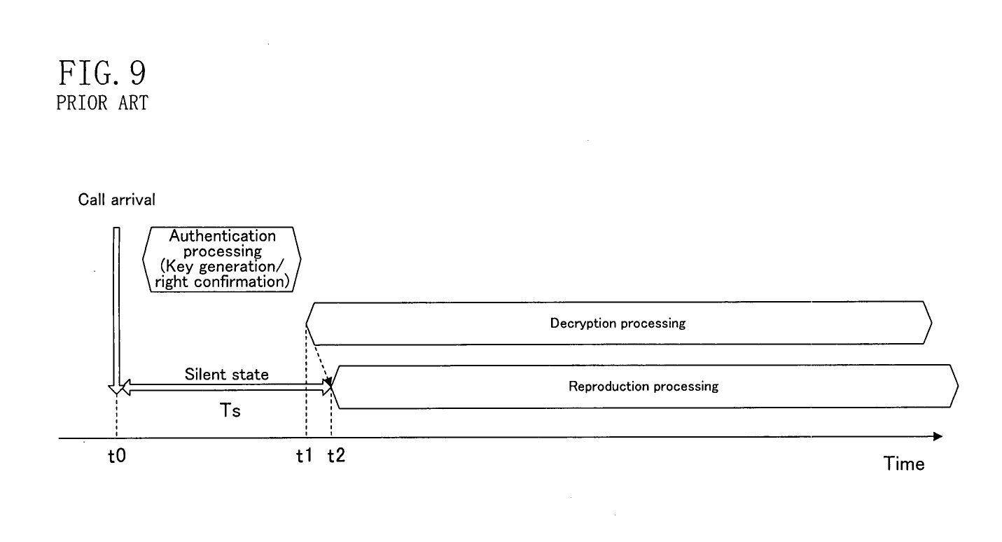

FIG. 8 shows a processing time series of an alternative plaintext data generation method and encrypted contents reproduction method. When a downloaded encrypted contents file is determined as an alert of an incoming call (t11), decryption of the encrypted contents file stored in the memory 11 or the memory card 25 is started (t12), and decrypted plaintext data is stored in the secure memory 14 (t13). In this example, the entire of the encrypted contents file stored in the memory 11 or the memory card 25 is decrypted. By storing the decrypted plaintext data in the secure memory 14, the copyright protection is secured.

When the mobile terminal 10 receives a call (t14), the authentication processing related to use of the encrypted contents file stored in the memory 11 or the memory card 25 is started simultaneously and in parallel with the reproduction of the plaintext data stored in the security memory 14. Once the authentication processing succeeds, the reproduction of the plaintext data is just continued. If the authentication processing fails, the processing shown in FIG. 3 is followed.

As described above, in the mobile terminal that reproduces an encrypted contents file as an alert of an incoming call, by performing the reproduction of the plaintext data and the authentication processing related to use of the encrypted contents file simultaneously and in parallel with each other, the contents can be reproduced promptly at the arrival of a call and the processing required at the reproduction can be lessened. Also, the copyright protection of the encrypted contents file is secured.

The encrypted contents reproduction method of the present invention can reproduce an encrypted contents file promptly while ensuring the copyright protection of the contents. Therefore, the inventive method is useful for mobile terminals that reproduce an encrypted contents file as call notification.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A mobile terminal adapted to reproduce an encrypted contents file stored in a predetermined storage area as an alert of an incoming call, the mobile terminal comprising:
a storage section for holding first plaintext data corresponding to a head portion of the encrypted contents file;
decryption means for decrypting the encrypted contents file to generate second plaintext data;
reproduction means for reproducing the first and second plaintext data; and
authentication means for performing authentication processing related to use of the encrypted contents file,
wherein the reproduction means reproduces the first plaintext data and in succession to reproduction of the first plaintext data reproduces the second plaintext data when the mobile terminal receives a call, and
the authentication means performs the authentication processing simultaneously and in parallel with the reproduction of the first plaintext data by the reproduction means.

2. The mobile terminal of claim 1, further comprising a control section for instructing the decryption means to decrypt the encrypted contents file if the authentication processing by the authentication means succeeds, and instructing the reproduction means to stop the reproduction of the first plaintext data if the authentication processing fails.

3. The mobile terminal of claim 1, wherein the storage section is a secure memory.

4. The mobile terminal of claim 1, wherein a remaining portion of the encrypted contents file excluding the head portion is stored in the predetermined storage area as the encrypted contents file.

5. A method for reproducing an encrypted contents file as an alert of an incoming call in a mobile terminal, first plaintext data corresponding to part of the encrypted contents file including a head portion thereof being held in a predetermined storage area, the encrypted contents reproduction method comprising the steps of:
(1) reproducing the first plaintext data when the mobile terminal receives a call;
(2) performing authentication processing related to use of the encrypted contents file simultaneously and in parallel with the step (1);
(3) decrypting the encrypted contents file to generate second plaintext data if the authentication processing in the step (2) succeeds; and
(4) reproducing the second plaintext data in succession to the step (1).

6. The encrypted contents reproduction method of claim 5, wherein the first plaintext data is data corresponding to a predetermined reproduction time.

7. The encrypted contents reproduction method of claim 5, wherein the first plaintext data is data having a predetermined data size.

8. The encrypted contents reproduction method of claim 5, wherein the first plaintext data is data corresponding to a predetermined number of frames.

9. A method for reproducing an encrypted contents file as an alert of an incoming call in a mobile terminal, plaintext data corresponding to the encrypted contents file being stored in a secure memory, the encrypted contents reproduction method comprising the steps of:
(1) reproducing the plaintext data when the mobile terminal receives a call; and
(2) performing authentication processing related to use of the encrypted contents file simultaneously and in parallel with the step (1).

10. The encrypted contents reproduction method of claim 9, further comprising the step (3) of stopping the reproduction of the plaintext data if the authentication processing in the step (2) fails.

11. The encrypted contents reproduction method of claim 10, further comprising the step (4) of deleting the plaintext data if the authentication processing in the step (2) fails.

12. A method for generating the first plaintext data, employed in the encryption contents reproduction method of claim 5, the plaintext data generation method comprising the steps of:
(1) decrypting part of the encrypted contents file including a head portion thereof; and
(2) storing data decrypted in the step (1) in the predetermined storage area as the first plaintext data.

13. The plaintext data generation method of claim 12, wherein in the step (1), in a first case that a frame break of the encrypted contents file exists within a predetermined range of reproduction time, encrypted data from the head of the encrypted contents file until the frame break is decrypted, and in a second case other than the first case, encrypted data from the head of the encrypted contents file until an upper limit of the range is decrypted, and
in the step (2), in the second case, data corresponding to a reproduction time within the range is stored in the predetermined storage area.

14. The plaintext data generation method of claim 12, wherein in the step (1), in a first case that a frame break of the encrypted contents file exists within a predetermined range of data size, encrypted data from the head of the encrypted contents file until the frame break is decrypted, and in a second case other than the first case, encrypted data from the head of the encrypted contents file until an upper limit of the range is decrypted, and
in the step (2), in the second case, data corresponding to a data size within the range is stored in the predetermined storage area.

15. The plaintext data generation method of claim 12, wherein the step (1) is executed when the encrypted contents file is determined as an alert of an incoming call.

16. The plaintext data generation method of claim 12, wherein the step (1) is executed when the encrypted contents file is stored in a predetermined storage area.
